(19) United States
(12) Patent Application Publication
(10) Pub. No.: US 2026/0241844 A1
(43) Pub. Date: Aug. 20, 2026

(54) SEAT AND METHOD FOR MANUFACTURING SEAT

(71) Applicant: DELTA KOGYO CO., LTD., Hiroshima (JP)

(72) Inventors: Yuki ARITA, Hiroshima (JP); Yuki SATO, Hiroshima (JP)

(73) Assignee: DELTA KOGYO CO., LTD., Hiroshima (JP)

(21) Appl. No.: 18/859,049

(22) PCT Filed: Apr. 28, 2023
(86) PCT No.: PCT/JP2023/016821

§ 371 Date: Oct. 22, 2024

(30) Foreign Application Priority Data
May 16, 2022 (JP) 2022-080448

(51) Int. Cl. B60N 2/64; B60N 2/58; B60N 2/68

(52) U.S. Cl. CPC B60N 2/64; B60N 2/5816; B60N 2/5891; B60N 2/68

(57) ABSTRACT

A seat includes a seatback. A seatback includes a cover member that covers a front surface and side surfaces of a frame, a backboard that covers a rear surface of the frame, a skin that covers a rear surface of the backboard, and a first engaging member. The cover member has a skin fixing part. The skin has a main part that covers the backboard and a pair of extension parts extending outward in a width direction of the main part. The extension part extends and turns toward a front side of the backboard to be disposed between the backboard and the skin fixing part. The first engaging member fixes the extension part to the skin fixing part by penetrating the extension part and engaging with the skin fixing part.

### TECHNICAL FIELD

The present invention relates to a seat including a seatback.

### BACKGROUND ART

A seat to be attached to a vehicle, such as an automobile, has been conventionally known for a structure generally including a seatback (or a backrest) for supporting the back of an occupant. A rear portion of the seatback includes a backboard fixed to a rear surface of a frame in the seat, and a rear surface trim being a skin that covers a rear surface of the backboard.

The rear surface trim is typically attached to cover an outer surface of the backboard after attachment of the backboard. In a conventional seat, such a rear surface trim is generally fixed to a side surface trim with a fastener, the side surface trim being a skin constituting the outer surface of the seat. The fastener is sewed to the rear surface trim and the side surface trim along respective edges thereof facing each other for the attachment. The rear surface trim is fixed to the side surface trim by closing the fastener after the attachment of the backboard.

Manufacture of a seat having such a fastener requires a step of sewing the fastener to a rear surface trim and a side surface trim along respective edges thereof, a step of attaching a backboard to a frame with a clip or other member, and a step of fixing the rear surface trim to the side surface trim with the fastener. This leads to an increase in the number of work steps in the manufacture of the seat, and further needs components for fixing the backboard and the rear surface trim individually, and hence faces difficulty in reducing manufacturing cost.

Structures described in Patent Literatures 1 to 2 have been known as seats each including a rear surface trim fixed without a fastener. In each structure, a sheet-shaped member corresponding to the rear surface trim is fixed to a backboard with a clip. Specifically, in the structure described in Patent Literature 1, a folded part of a carpet member is fixed to a backboard with a clip at a rear portion of a seat rear surface. In the structure described in Patent Literature 2, a skin fits in a fit hole of a backboard to be fixed thereto with a clip at a rear side of a seat.

Each of the structures in Patent Literatures 1 to 2 including the rear surface trim fixed to the backboard with the clip in place of a fastener requires an additional member and an additional work to fix the backboard to a frame or other component, and thus is still unsatisfactory in terms of improvement in workability.

### CITATION LIST

### Patent Literature

Patent Literature 1: Japanese Patent Publication No. 5387635

Patent Literature 2: Japanese Unexamined Patent Publication No HEI 8-256874

### SUMMARY OF INVENTION

The present invention has been accomplished in view of the circumstances described above, and has an object of providing a seat that achieves improvement in workability in a work of fixing a backboard and a skin at a rear side of a seatback.

To achieve the aforementioned object, a seat in the present invention includes a seatback. The seatback includes: a frame serving as a base of the seatback; a cover member that covers a front surface of the frame; a backboard that covers a rear surface of the frame; a skin that covers a rear surface of the backboard; and a first engaging member that fixes the skin to the cover member. The cover member has a front surface part that covers the front surface of the frame, a pair of side surface parts that cover side surfaces of the frame respectively, and a skin fixing part located in a space defined among the front surface part and the pair of side surface parts and having a first engaged hole which is engageable with the first engaging member. The skin has a main part that covers a rear side of the backboard, and an extension part extending from a peripheral edge of the main part and turning toward a front side of the backboard to be disposed between the backboard and the skin fixing part. The first engaging member fixes the extension part to the skin fixing part by penetrating the extension part and engaging with the first engaged hole of the skin fixing part.

### BRIEF DESCRIPTION OF DRAWINGS

FIG. 1 is a perspective view of an overall configuration of a seatback in a seat according to an embodiment of the present invention.

FIG. 2 is an exploded perspective view of the seatback in FIG. 1.

FIG. 3 is a perspective view of a cover member in FIG. 2 seen from rear and upper right.

FIG. 4 is a back view of the cover member in FIG. 2 seen from the rear.

FIG. 5 is a plan view of the cover member in FIG. 2.

FIG. 6 is an explanatory view showing a method for manufacturing the seatback in FIG. 2, and illustrates a state before a pair of reinforcement plate members in FIG. 2 are sewn to a pair of extension parts of a rear surface trim.

FIG. 7 is an explanatory view showing the method for manufacturing the seatback in FIG. 2, and illustrates a state after the pair of reinforcement plate members in FIG. 2 are sewn to the pair of extension parts of the rear surface trim.

FIG. 8 is an explanatory view showing the method for manufacturing the seatback in FIG. 2, and illustrates a state after a first clip penetrates the reinforcement plate member and the extension part of the rear surface trim from the front and a second clip penetrates the backboard from the rear.

FIG. 9 is an explanatory view showing the method for manufacturing the seatback in FIG. 2, and illustrates a state where the extension part of the rear surface trim is being bent frontward and turned around the backboard.

FIG. 10 is an explanatory view showing the method for manufacturing the seatback in FIG. 2, and illustrates a state after the extension part of the rear surface trim is turned toward the front side of the backboard and where the reinforcement plate member overlaps a front surface of the backboard and a reinforcement plate extension part engages with the front surface of the backboard with the second clip.

FIG. 11 is an explanatory view showing the method for manufacturing the seatback in FIG. 2, and illustrates a state where the first clip is being made engage with a first engaged hole of a skin fixing part of the cover member and the second clip is being made engage with a second engaged hole of a frame.

FIG. 12 is an explanatory view showing the method for manufacturing the seatback in FIG. 2, and illustrates a state after the first clip engages with the first engaged hole of the skin fixing part of the cover member and the second clip engages with the second engaged hole of the frame, that is, a state where the seatback is completed.

FIG. 13 is an exploded perspective view of a seatback without a second clip and a reinforcement plate extension part in a modification of the seat in the present invention.

FIG. 14 is an explanatory view showing a method for manufacturing the seatback in FIG. 13, and illustrates a state where a first clip penetrates a reinforcement plate member and an extension part of a rear surface trim from the front.

FIG. 15 is an explanatory view showing the method for manufacturing the seatback in FIG. 13, and illustrates a state where the extension part of the rear surface trim is being bent frontward and tuned around the backboard.

FIG. 16 is an explanatory view showing the method for manufacturing the seatback in FIG. 13, and illustrates a state after the extension part of the rear surface trim is turned frontward and around the backboard and where the reinforcement plate member overlaps a front surface of the backboard.

FIG. 17 is an explanatory view showing the method for manufacturing the seatback in FIG. 13, and illustrates a state where the first clip is being made engage with a first engaged hole of a skin fixing part of the cover member.

FIG. 18 is an explanatory view showing the method for manufacturing the seatback in FIG. 13, and illustrates a state after the first clip engages with the first engaged hole of the skin fixing part of the cover member, that is, a state where the seatback is completed.

FIG. 19 is an explanatory view showing a method for manufacturing a seatback in another modification of the seat in the present invention, and illustrates a state where an extension part of a rear surface trim is being turned around a backboard having a protrusion and immediately before a reinforcement plate extension part engages with the protrusion of the backboard.

FIG. 20 is an explanatory view illustrating a state where the protrusion of the backboard in FIG. 19 is engaged with the reinforcement plate extension part and after a first clip engages with a first engaged hole of a skin fixing part of a cover member, that is, a state where the seatback is completed.

### DESCRIPTION OF EMBODIMENTS

Hereinafter, a seat according to each embodiment of the present invention will be described in detail with reference to the accompanying drawings.

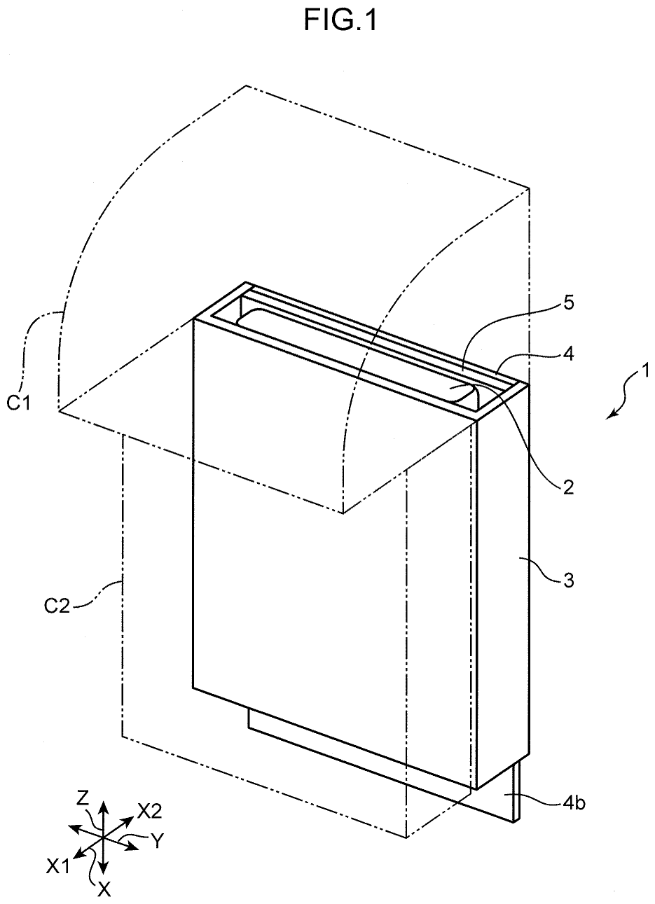

As illustrated in FIG. 1, a seat according to an embodiment of the present invention includes a seatback 1 (or a backrest) for supporting the back of an occupant and a seat cushion (not shown) for supporting the buttocks of the occupant.

The seatback 1 illustrated in FIG. 1 is an example seatback for a middle seat of a three-seater rear seat for a vehicle. The seatback 1 has an external appearance in a substantially vertically rectangular parallel-piped shape with a width which is suitable to support the back in a width direction Y. A back upper portion cushion C1 for supporting an upper portion of the back of the occupant is arranged above the seatback 1, and a front portion cushion C2 is arranged frontward X1 from the seatback 1. The front portion cushion C2 is shiftable between a standing position along a front surface of the seatback 1 and a lying position frontward X1. The front portion cushion C2 can support the back of the occupant in the standing position, and is available as an armrest in the reclined position frontward X1.

The drawings to be referred to in the embodiment show a front-rear direction denoted by an arrow X (frontward or front side X1, rearward or rear side X2), a width direction denoted by an arrow Y, and an up-down direction denoted by an arrow Z relative to the seatback 1.

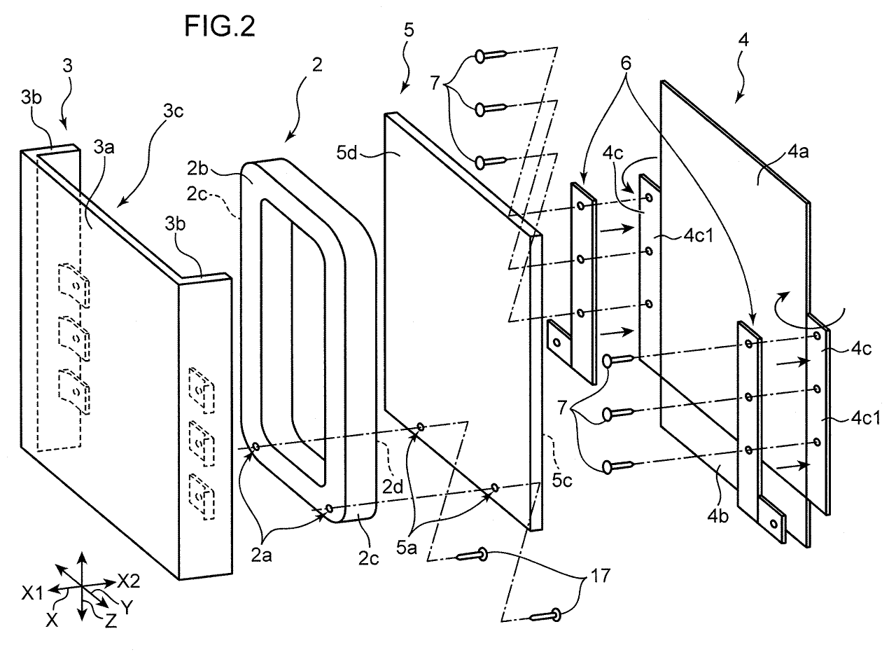

As illustrated in FIG. 1 to FIG. 2, the seatback 1 includes: a vertical frame 2 serving as a base of the seatback 1; a cover member 3 that covers a front surface 2b and side surfaces 2c of the frame 2; a backboard 5 that covers a rear surface 2d of the frame 2; a rear surface trim 4 being a skin that covers a rear surface 5c of the backboard 5; a plurality of (six in the embodiment) first clips 7 each being a first engaging member that fixes the rear surface trim 4 to the cover member 3 (specifically, a trim fixing part 3d to be described later); and a plurality of (two in the embodiment) second clips 17 each being a second engaging member that fixes the backboard 5 to the frame 2. In the embodiment, the rear surface trim 4 has a pair of reinforcement plate members 6 serving as reinforcement parts that reinforce a pair of extension parts 4c of the rear surface trim 4 to be described later.

The frame 2 in the embodiment is a vertical rectangular frame, and has the front surface 2b, the side surfaces 2c, and the rear surface 2d. The frame 2 has, at a lower beam part thereof, a pair of second engaged holes 2a which are engageable with the second clips 17 respectively and are apart from each other in the width direction Y.

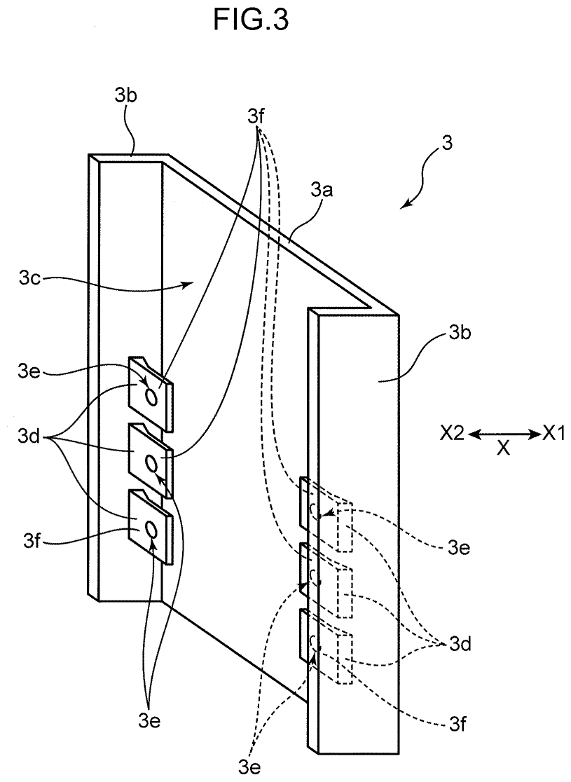

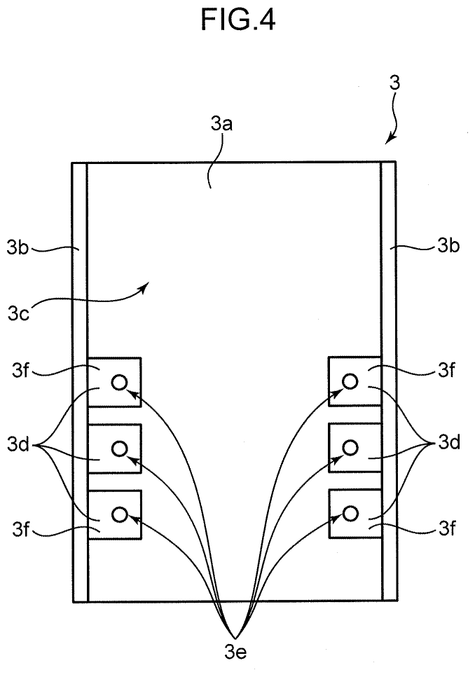

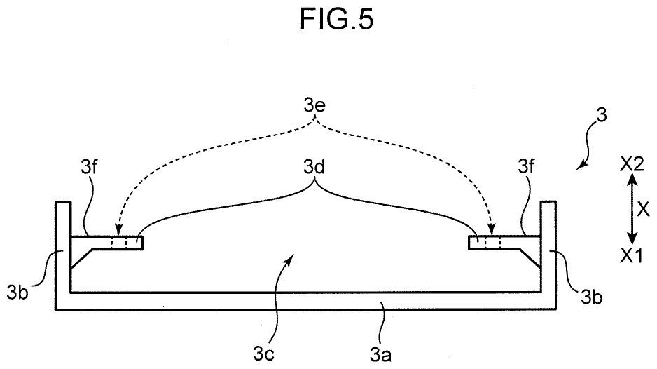

As illustrated in FIG. 2 to FIG. 5, the cover member 3 has a front surface part 3a that covers the front surface 2b of the frame 2, and a pair of side surface parts 3b that extend rearward X2 from side edges of the front surface part 3a and cover the side surfaces 2c of the frame 2 respectively. The cover member 3 has a space 3c defined among the front surface part 3a and the pair of side surface parts 3b and opening rearward X2 (see FIG. 2 to FIG. 3, and FIG. 5).

The cover member 3 further has a plurality of (six in the embodiment) trim fixing parts 3d (skin fixing parts) in the space 3c and configured to fix the rear surface trim 4 thereto. In the embodiment, three trim fixing parts 3d are provided to each of inner surfaces of the pair of side surface parts 3b facing each other.

Each trim fixing part 3d has a contact surface 3f facing a rear side X2 of the cover member 3, and a first engaged hole 3e provided on the contact surface 3f that is engageable with the associated first clip 7.

As illustrated in FIG. 2, the backboard 5 is a rectangular plate-shaped member having such a dimension as to cover the rear surface 2d of the frame 2. The backboard 5 has a lower end having a pair of through holes 5a located to meet the pair of second engaged holes 2a of the frame 2. The backboard 5 is made of material having such hardness as to avoid a dent attributed to hitting of a foot of an occupant, for example, is made of corrugated plastic board or thick plastic board.

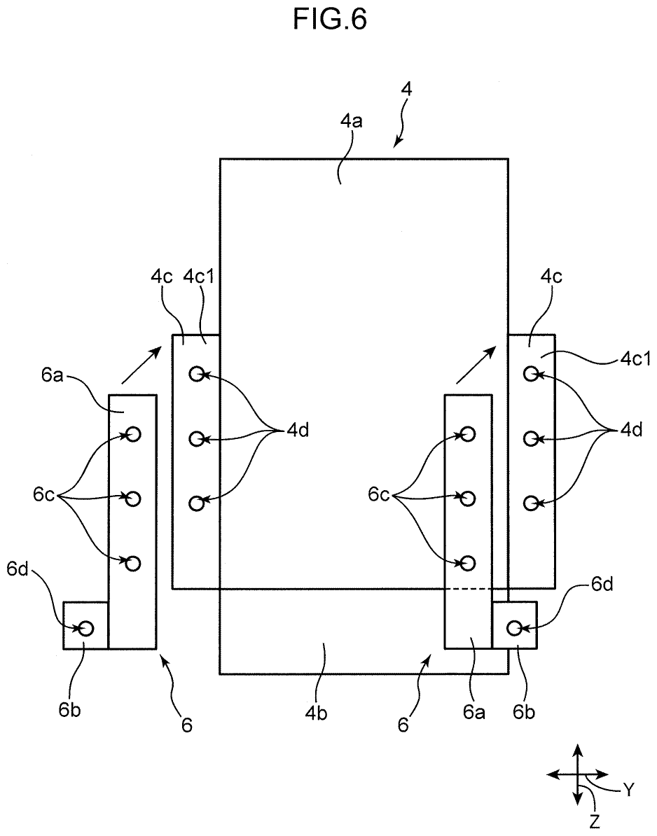

As illustrated in FIG. 2 and FIG. 6, the rear surface trim 4 is a thin sheet-shaped member, and has a main part 4a having a rectangular shape with such a dimension (being equal to or slightly larger than the backboard 5) as to cover a rear side X2 of the backboard 5, a lower band part 4b extending downward from the main part 4a, and a pair of extension parts 4c. The rear surface trim 4 is only required to be a thin sheet-shaped member having flexibility, and may be made of natural leather, synthetic leather, synthetic resin material, or other material. The lower band part 4b is fixed to a lower end of the frame 2 or at other predetermined attachment position thereof. The lower band part 4b is not indispensable for the present invention, and thus may be omitted.

The pair of extension parts 4c extend outward in the width direction Y of the main part 4a from opposite side edges of the main part 4a in the width direction Y. Each extension part 4c has a width (dimension in the width direction Y) which is large enough to extend and turn toward the front side X1 of the backboard 5 overlapping the main part 4a and to enfold the side end of the backboard 5.

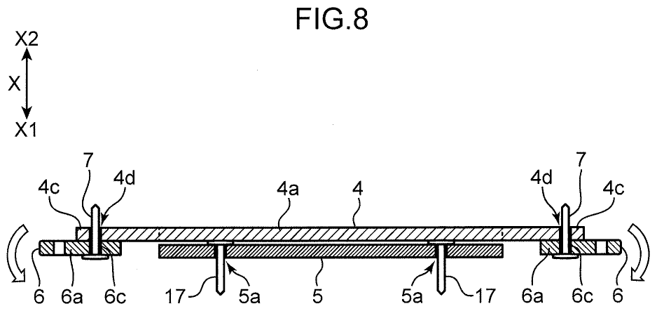

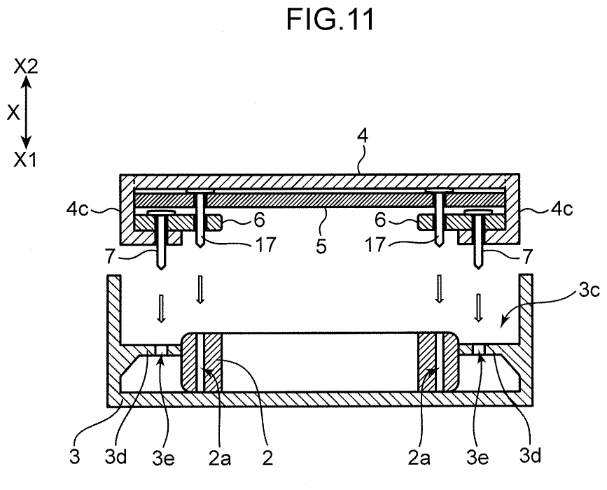

The pair of extension parts 4c have through holes 4d at such heights as to respectively meet first engaged holes 3e of the six trim fixing parts 3d of the cover member 3. Each through hole 4 is located to align with the first engaged hole 3e of the trim fixing part 3d of the cover member 3 with the associated extension part 4c illustrated in FIG. 8 and FIG. 11 enfolding the side end of the backboard 5.

As illustrated in FIG. 2 and FIG. 6, the rear surface trim 4 in the embodiment has the pair of reinforcement plate members 6 respectively serving as reinforcement parts that reinforce the peripheries of the through holes 4d of the pair of extension parts 4c that the first clips 7 penetrate through. Specifically, the reinforcement parts in the embodiment are formed of the pair of reinforcement plate members 6 fixed to front surfaces 4cl of the pair of extension parts 4c to reinforce the extension parts 4c.

Each reinforcement plate member 6 is preferably made of material having appropriate hardness to reinforce the associated extension part 4c, having appropriate elasticity for facilitated turning of the extension part 4c, and having a light weight. For instance, a thin-plate made of synthetic resin, such as polypropylene (PP), may be adopted. Various kinds of materials including a thin metal plate and a cardboard member are adoptable as long as each material has at least such hardness.

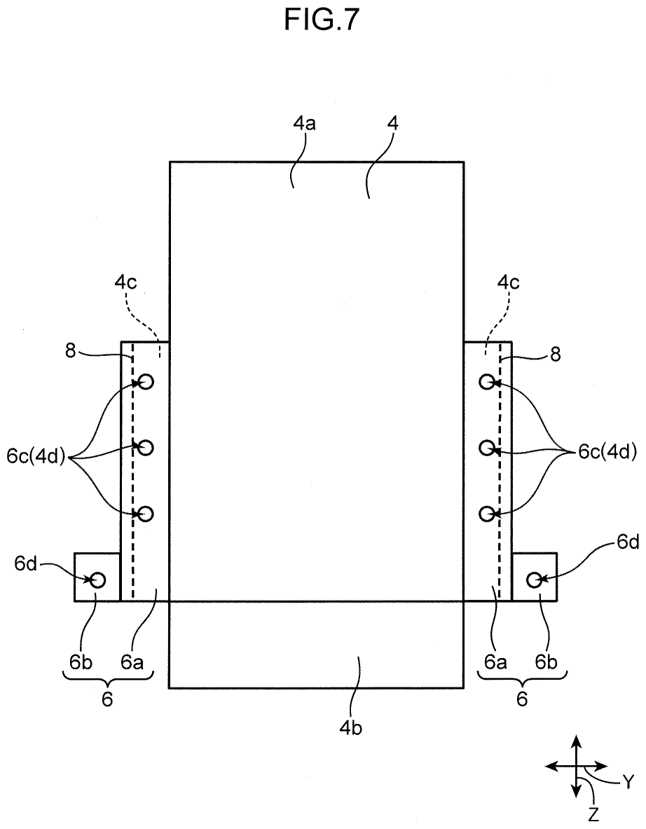

The reinforcement plate member 6 is fixed through sewing (see sewn sections 8 in FIG. 7) to the extension part 4c, but may be fixed through adhesion or by another way.

As a specific configuration, the reinforcement plate member 6 has substantially the same dimension as the extension part 4c, and has a reinforcement plate main part 6a overlapping the extension part 4c in the front-rear direction X, and a reinforcement plate extension part 6b extending in the width direction Y from the reinforcement plate main part 6a to such a position as to avoid overlapping the extension part 4c.

The reinforcement plate main part 6a has three through holes 6c to meet the three through holes 4d of the extension part 4c respectively.

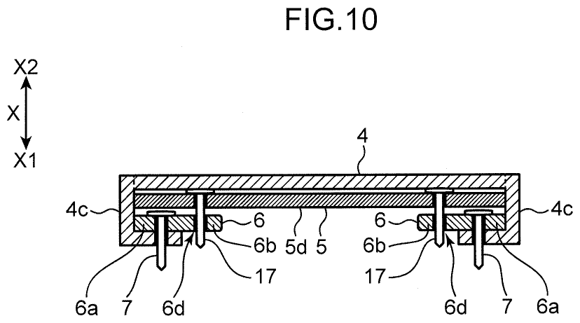

The reinforcement plate extension part 6b has a structure fixable to a front surface 5d of the backboard 5. Specifically, the reinforcement plate extension part 6b has a third engaged hole 6d being a through hole which is engageable with the associated second clip 17 so that the reinforcement plate extension part 6b is fixed to the front surface 5d of the backboard 5. The third engaged hole 6d is located at a position corresponding to the height of the pair of second engaged holes 2a of the frame 2. More specifically, the third engaged hole 6d is located to align the associated through hole 5a of the backboard 5 with the extension part 4c of the rear surface trim 4 illustrated in FIG. 8 and FIG. 10 turning toward the front side of X1 of the backboard 5 and enfolding the side end of the backboard 5.

As illustrated in FIG. 2, each first clip 7 is a member to fix the extension part 4c and the reinforcement plate member 6 of the rear surface trim 4 to the trim fixing part 3d of the cover member 3. A clip made of resin and being available at a reasonable price is adopted.

Each second clip 17 is a member to fix the backboard 5 and the reinforcement plate member 6 to the rear surface 2d of the frame 2. For instance, a clip made of resin and being available at a reasonable price is adopted.

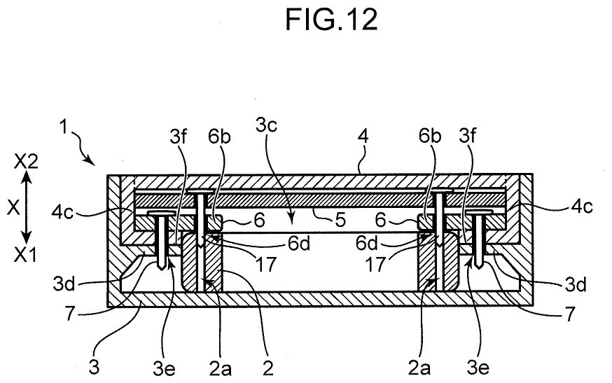

The constituent components of the seatback 1 illustrated in FIG. 1 to 7 are assembled in a manner illustrated in FIG. 12 to complete the seatback 1.

At the seatback 1 illustrated in FIG. 12, the pair of extension parts 4c of the rear surface trim 4 are bent toward the front side X1 of the backboard 5 and turned toward the front side X1 of the backboard 5. In this state, each of the pair of extension parts 4c is disposed between the backboard 5 and the associated trim fixing part 3d. The pair of reinforcement plate members 6 overlap the front side X1 of the backboard 5.

Each first clip 7 penetrates the extension part 4c and the reinforcement plate member 6, and a leading end of the first clip 7 engages with the first engaged hole 3e of the trim fixing part 3d. Consequently, the pair of extension part 4c of the rear surface trim 4 are fixed to the trim fixing parts 3d while being in contact with the contact surfaces 3f of the trim fixing parts 3d.

Each second clip 17 fixes the backboard 5 to the frame 2 together with the reinforcement plate member 6 by penetrating the backboard 5 and engaging the reinforcement plate extension part 6b with the front surface 5d of the backboard 5 through the third engaged hole 6d of the reinforcement plate extension part 6b, and engaging with the second engaged hole 2a of the frame 2.

### Method for Manufacturing the Seatback 1

The seatback 1 having the configuration described above is specifically manufactured in a procedure described below.

As illustrated in FIG. 6 to FIG. 7, first, the reinforcement plate main parts 6a of the pair of reinforcement plate members 6 are laid over and sewn to the pair of extension parts 4c of the rear surface trim 4 respectively in the-up-down direction Z to form the sewn sections 8. In the sewing, the through holes 6c of the reinforcement plate main parts 6a and the through holes 4d of the extension part 4c are made align.

Subsequently, as illustrated in FIG. 8, the second clips 17 are inserted in the pair of through holes 5a of the backboard 5 from the rear side X2 respectively to penetrate the backboard 5. Then, the first clips 7 are inserted in the through holes 6c of the associated reinforcement plate main part 6a and the through holes 4d of the associated extension part 4c from the front side X1 to penetrate the reinforcement plate member 6 and the extension part 4c. Then, the main part 4a of the rear surface trim 4 is overlapped with the backboard 5 from the rear side X2.

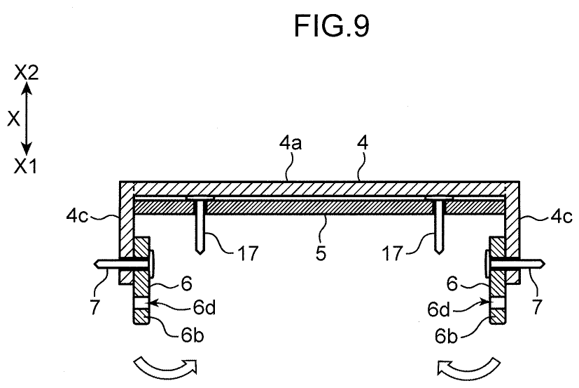

Further, as illustrated in FIG. 8 to FIG. 10, the pair of extension parts 4c of the rear surface trim 4 are turned frontward X1 to combine the rear surface trim 4 and the backboard 5. Specifically, the pair of reinforcement plate members 6 are overlapped with the front surface 5d of the backboard 5 by bending and turning the pair of extension parts 4c to enfold side ends of the backboard 5 respectively. At the same time, each second clip 17 is made penetrate through the third engaged hole 6d of the associated reinforcement plate extension part 6b to engage the reinforcement plate extension part 6b with the front surface 5d of the backboard 5. The extension part 4c is turned toward the front side X1 of the backboard 5 so that the first clip 7 is located at the front side X1 of the backboard 5.

Although the rear surface trim 4, the backboard 5, and the reinforcement plate member 6 are slightly apart from one another to be visually recognized in FIG. 8 to FIG. 12, these components are in close contact among the components in reality.

Next, as illustrated in FIG. 11 to FIG. 12, the rear surface trim 4 and the backboard 5 combined by the pair of extension parts 4c of the rear surface trim 4 enfolding the side ends of the backboard 5 respectively are brought closer to the frame 2 and the trim fixing parts 3d in the space 3c of the cover member 3 from the rear side X2, and each first clip 7 is made engage with the associated first engaged hole 3e of the trim fixing part 3d of the cover member 3. At the same time, each second clip 17 is made engage with the associated second engaged hole 2a of the frame 2. This enables simultaneous fixing of the rear surface trim 4 and the backboard 5 to the cover member 3 and the frame 2. Consequently, the seatback 1 having the structure illustrated in FIG. 12 is completed.

### Characteristics of the Embodiment

(1) In the seat in the embodiment, as illustrated in FIG. 2 and FIG. 12, the rear surface trim 4 that covers the rear side X2 of the backboard 5 of the seatback 1 has the main part 4a that covers the rear side X2 of the backboard 5 and the pair of extension parts 4c each extending from a peripheral edge of the main part 4a and turning toward the front side X1 of the backboard 5 to be disposed between the backboard 5 and the trim fixing part 3d (skin fixing part). The configuration achieves simultaneous attachment of the rear surface trim 4 and the backboard 5 by combining the rear surface trim 4 and the backboard 5 by the pair of extension parts 4c.

In other words, in manufacturing the seatback 1, turning the pair of extension parts 4c toward the front side X1 of the backboard 5 leads to achievement in combining the rear surface trim 4 and the backboard 5 together with the reinforcement plate member 6. Besides, each first clip 7 enables fixing of the associated extension part 4c to the trim fixing part 3d by penetrating the extension part 4c and the reinforcement plate member 6 and engaging with the associated first engaged hole 3e of the trim fixing part 3d of the cover member 3. The configuration enables simultaneous fixing of the rear surface trim 4 and the backboard 5 to the cover member 3 and the trim fixing part 3d. This results in achieving improvement in the workability in the work of fixing the backboard 5 and the rear surface trim 4 at the rear side X2 of the seatback 1.

The seatback 1 having this configuration further enables the simultaneous fixing of the backboard 5 and the rear surface trim 4 with a resin clip being available at a reasonable price as the first clip 7 without the need for a fastener for assembling of the backboard 5 and the rear surface trim 4 at the seatback 1. The configuration eliminates the need for such a fastener in terms of the external appearance of the seat, and thus improves the external appearance of the seatback 1. The simultaneous fixing of the backboard 5 and the rear surface trim 4 with the resin clip (or the first clip 7) being available at a reasonable price leads to a reduction in the manufacturing cost. In particular, in the seatback 1, a simple work of engaging the first clip 7 with the first engaged hole 3e of the trim fixing part 3d of the cover member 3 achieves the simultaneous fixing of the rear surface trim 4 and the backboard 5 to the cover member 3. This eliminates a complicated sewing work for attaching a fastener to the rear surface trim 4 as adopted in conventional manufacture of a seat, and thus is very advantageous from the perspective of the reduction in the manufacturing cost.

Besides, the reinforcement of the extension part 4c of the rear surface trim 4 by the reinforcement plate member 6 avoids breakage of the extension part 4c fixed with the first clip 7 around the periphery of the through hole 4d. Moreover, the extension part 4c having been fixed with the first clip 7 and the periphery therearound has no crease or distortion, and thus the appearance of the rear surface trim 4 improves.
(2) In the seat in the embodiment, the rear surface trim 4 has the pair of reinforcement plate members 6 respectively serving as reinforcement parts that reinforce peripheries of the through holes 4d of the pair of extension parts 4c that the associated first clips 7 penetrate through. The configuration prevents each first clip 7 from elongating the through hole 4d.

In the embodiment, each reinforcement plate member 6 serving as the reinforcement part is fixed to the front surface 4cl of the associated extension part 4c to reinforce the extension part 4c. The adoption of the reinforcement plate member 6 leads to facilitated and ensured reinforcement of the whole of the extension part 4c. The reinforcement plate member 6 reliably brings out a straight line at an enfolding portion of the extension part 4c, resulting in improving the appearance of the rear surface trim 4.

Furthermore, the reinforcement plate member 6 has stiffness which is higher than the stiffness of the extension part 4c, and thus allows the extension part 4c to smoothly bent at the reinforcement plate member 6. This allows the extension part 4c to easily enfold the backboard 5.

Although the embodiment exemplifies the reinforcement plate member 6 fixed to the front surface 4cl of the extension part 4c as the reinforcement part to reinforce the extension part 4c, the present invention is not limited thereto. The reinforcement part may be a member other than the reinforcement plate member 6 as long as the reinforcement part reinforces at least the periphery of the portion (through hole 4d) of the extension part 4c that the first clip 7 penetrates. Examples of other reinforcement part include a metal ring (grommet or eyelet) fit to the periphery of the through hole 4d of the extension part 4c, and a resin layer or an adhesive layer impregnated and held in the periphery of the through hole 4d of the extension part 4c.
(3) As illustrated in FIG. 6 to 7 and FIG. 10, in the seat in the embodiment, the reinforcement plate member 6 has the reinforcement plate main part 6a overlapping the extension part 4c and the reinforcement plate extension part 6b extending from the reinforcement plate main part 6a to such a position as to avoid overlapping the extension part 4c. The reinforcement plate extension part 6b has a structure fixable to the front surface 5d of the backboard 5. Specifically, the reinforcement plate extension part 6b has the third engaged hole 6d being a through hole which is engageable with the associated second clip 17 penetrating the backboard 5 so that the reinforcement plate extension part 6b is fixed to the front surface 5d of the backboard 5.

This configuration results in fixing the reinforcement plate extension part 6b to the front surface 5d of the backboard 5. Specifically, the second clip 17 penetrating the backboard 5 engages with the third engaged hole 6d of the reinforcement plate extension part 6b to fix the reinforcement plate extension part 6b to the front surface 5d of the backboard 5. The configuration allows the reinforcement plate member 6 to keep overlapping the backboard 5. This consequently avoids displacement of the reinforcement plate member 6 relative to the backboard 5 in the work of fixing the extension part 4c of the rear surface trim 4 to the trim fixing part 3d of the cover member 3 with the first clip 7, and thus improves the workability.
(4) In the seat in the embodiment, the seatback 1 includes the second clip 17 that fixes the backboard 5 to the frame 2. The frame 2 has the second engaged hole 2a which is engageable with the second clip 17. As described above, the reinforcement plate extension part 6b has the third engaged hole 6d being a through hole which is engageable with the second clip 17 so that the reinforcement plate extension part 6b is fixed to the front surface 5d of the backboard 5.

As illustrated in FIG. 12, the second clip 17 fixes the backboard 5 to the frame 2 together with the reinforcement plate member 6 in the state of penetrating the backboard 5 by engaging the reinforcement plate extension part 6b with the front surface 5d of the backboard 5 through the third engaged hole 6d of the reinforcement plate extension part 6b and engaging with the second engaged hole 2a of the frame 2.

In this configuration, the second clip 17 penetrates through the third engaged hole 6d of the reinforcement plate extension part 6b to engage the reinforcement plate extension part 6b with the front surface 5d of the backboard 5. The configuration thus avoids displacement of the reinforcement plate member 6 relative to the backboard 5 in the work of fixing the extension part 4c of the rear surface trim 4 to the trim fixing part 3d of the cover member 3 with the first clip 7, and thus improves the workability. Further, the engagement of the second clip 17 with the second engaged hole 2a leads to fixing of the backboard 5 to the frame 2 together with the reinforcement plate member 6. This attains further stable fixing of the backboard 5, the reinforcement plate member 6, and the extension part 4c of the rear surface trim 4 fixed to the reinforcement plate member 6, and achieves improvement in accuracy of positioning and attachment of these components.
(5) As illustrated in FIG. 2 and FIG. 6, in the seat in the embodiment, the extension part 4c of the rear surface trim 4 extends outward in the width direction Y of the main part 4a from each of the opposite side edges of the main part 4a in the width direction Y. The trim fixing part 3d of the cover member 3 is provided to each of the inner surfaces of the pair of side surface parts 3b facing each other.

This configuration achieves stable support of the backboard 5 from the opposite sides thereof in the width direction Y by allowing the pair of extension parts 4c of the rear surface trim 4 to turn toward the front side X1 of the backboard 5. The configuration further enables stable fixing of the rear surface trim 4 and the backboard 5 to the trim fixing parts 3d respectively provided to the pair of side surface parts 3b of the cover member 3.
(6) A method for manufacturing a seat in the embodiment enables continuous execution of a step of combining the rear surface trim 4 and the backboard 5 by each extension part 4c of the rear surface trim 4, and a step of simultaneously attaching the rear surface trim 4 and the backboard 5 to the trim fixing part 3d of the cover member 3.

In other words, in manufacturing the seatback 1, turning the extension part 4c toward the front side X1 of the backboard 5 together with the first clip 7 after penetration of the first clip 7 from the front side X1 of the extension part 4c of the rear surface trim 4 leads to achievement in combining the rear surface trim 4 and the backboard 5. At this time, the first clip 7 is at the front side X1 of the backboard 5. Subsequently to the step of combining the rear surface trim 4 and the backboard 5, the rear surface trim 4 and backboard 5 in combination are brought closer to the frame 2 and the trim fixing part 3d in the space 3c of the cover member 3 from the rear side X2, and the first clip 7 is made engage with the first engaged hole 3e of the trim fixing part 3d of the cover member 3. The method enables fixing of the extension part 4c to the trim fixing part 3d. This results in achieving improvement in the workability in the work of fixing the backboard 5 and the rear surface trim 4 at the rear side X2 of the seatback 1.

### Modifications

(A) In the seat according to the embodiment, the seatback 1 includes: the second clip 17 (see FIG. 2 and FIG. 12) that fixes the backboard 5 to the frame 2; and the reinforcement plate extension part 6b (see FIG. 6 and FIG. 12) engaged with the second clip 17. In this regard, a configuration without the second clip 17 and the reinforcement plate extension part 6b exerts the features (1), (2), and (5) of the embodiment described above.

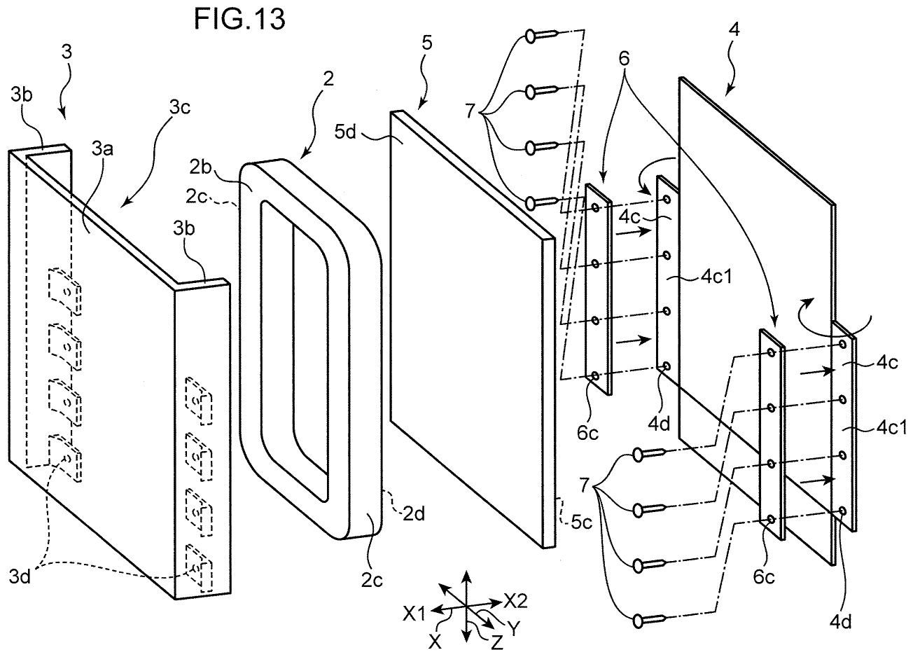

For instance, a modification of the present invention includes a seatback without the second clip 17 and the reinforcement plate extension part 6b as illustrated in FIG. 13.

As illustrated in FIG. 13, the seatback includes no second clip 17 and no reinforcement plate extension part 6b. Instead, the seatback includes four first clips 7, four trim fixing parts 3d in a cover member 3, four through holes 4d in an extension part 4c of a rear surface trim 4, and four through holes 6c in a reinforcement plate member 6 at each of the opposite positions of the seatback in a width direction Y thereof. This attains stable fixing of a pair of extension parts 4c of the rear surface trim 4 to the cover member 3. The seatback in FIG. 13 includes no through hole 5a in the backboard 5 and no second engaged hole 2a in the frame 2 in association with the absence of the second clip 17.

A method for manufacturing the seatback in the modification illustrated in FIG. 13 includes the following facilitated steps in relation to the absence of the second clip 17.

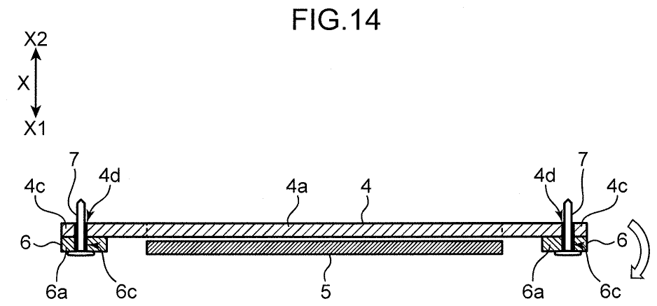

As illustrated in FIG. 14, first, each first clip 7 is inserted in a through hole 6c of an associated reinforcement plate main part 6a and a through hole 4d of an associated extension part 4c from the front side X1. Then, a main part 4a of the rear surface trim 4 is overlapped with a backboard 5 from the rear side X2.

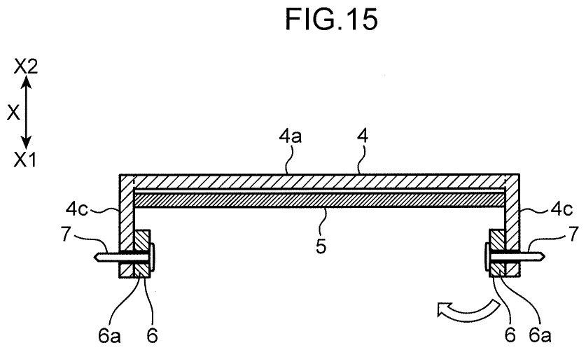

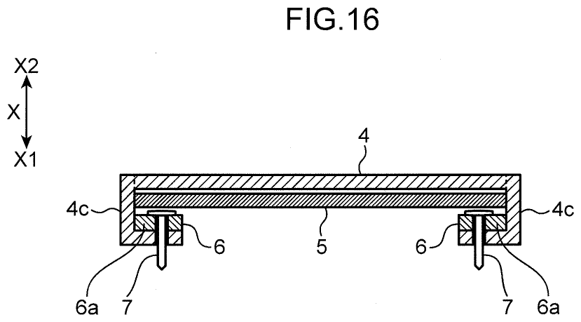

Next, as illustrated in FIG. 14 to FIG. 16, a pair of reinforcement plate members 6 are overlapped with a front surface 5d of the backboard 5 by bending and turning a pair of extension parts 4c of the rear surface trim 4 frontward X1 with the pair of extension parts 4c enfolding side ends of the backboard 5.

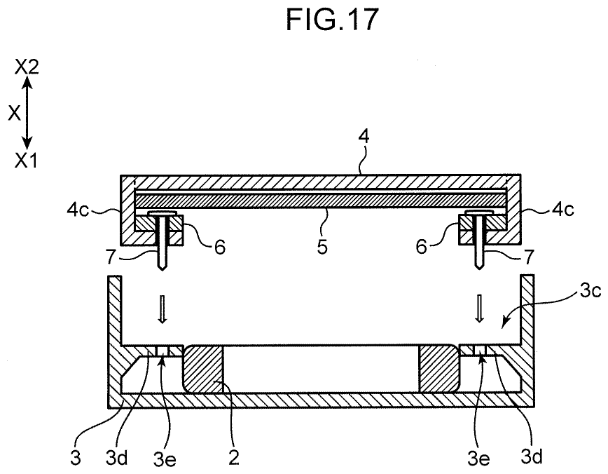

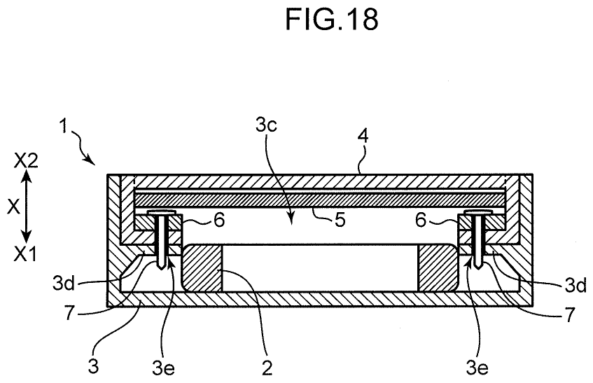

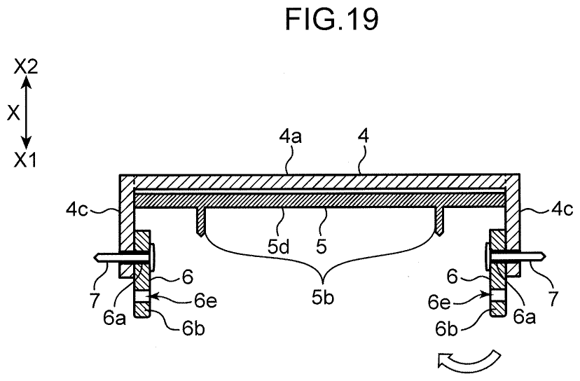

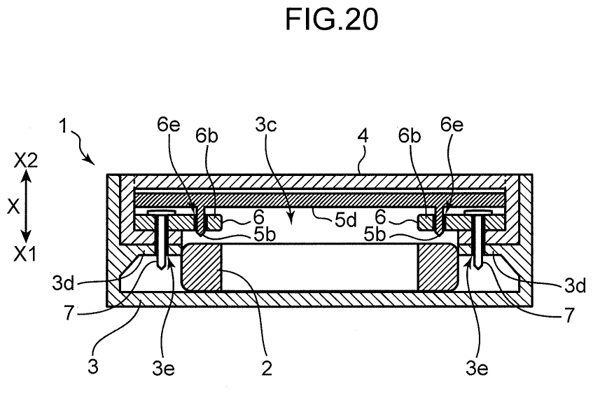

Subsequently, as illustrated in FIG. 17 to FIG. 18, the first clip 7 is made engage with a first engaged hole 3e of a trim fixing part 3d of the cover member 3 by each of the pair of extension parts 4c of the rear surface trim 4 folding the side ends of the backboard 5. This enables the simultaneous fixing of the rear surface trim 4 and the backboard 5 to the cover member 3. Consequently, the seatback having the structure illustrated in FIG. 18 is completed.
(B) A configuration including a reinforcement plate member 6 having no reinforcement plate extension part 6b in the embodiment may attain more stable fixing of the backboard 5 by fixing the backboard 5 to the frame 2 with a second clip 17. The configuration exerts the features (1), (2), and (5) in the embodiment described above.
(C) FIG. 19 to FIG. 20 illustrate another modification of the present invention that includes a backboard 5 having a protrusion 5b protruding from a front surface 5d of the backboard 5 in place of the second clip 17 in the embodiment. In this configuration, a reinforcement plate extension part 6b may have a fourth engaged hole 6e which is engageable with the protrusion 5b.

As for the backboard 5 in the modification, a plastic molded article integrally formed with the protrusion 5b or other article is adoptable.

In the modification illustrated in FIG. 19 to FIG. 20, the protrusion 5b protruding frontward X1 from the front surface 5d of the backboard 5 engages with the fourth engaged hole 6e of the reinforcement plate extension part 6b to engage the reinforcement plate extension part 6b with the front surface 5d of the backboard 5. The configuration thus avoids displacement of a reinforcement plate member 6 relative to the backboard 5 in a work of fixing an extension part 4c of a rear surface trim 4 to a trim fixing part 3d of a cover member 3 with a first clip 7, and thus improves the workability.

A reverse configuration comparable to the modification illustrated in FIG. 19 to FIG. 20, specifically, a configuration including a reinforcement plate extension part 6b having a protrusion and a backboard 5 having an engaged hole also achieves fixing of the reinforcement plate extension part 6b to the backboard 5.
(D) The extension part 4c of the rear surface trim 4 may extend in the up-down direction Z as well as extending in the width direction Y of the main part 4a shown in the embodiment and the modifications (A) to (C). A cover member 3 may have a trim fixing part 3d located at an end in a space 3c in the up-down direction Z to meet the extension part 4c. In the same manner as the embodiment, this configuration achieves fixing of the extension part 4c of the rear surface trim 4 being in contact with a contact surface 3f of the trim fixing part 3d of the cover member 3 to the trim fixing part 3d by making a first clip 7 penetrate the extension part 4c and a reinforcement plate member 6 and engage with a first engaged hole 3e of the trim fixing part 3d in a state where the extension part 4c turns toward the front side X1 of a backboard 5, enfolds the opposite ends of the backboard 5 in the up-down direction Z, and overlaps the reinforcement plate member 6. This enables simultaneous fixing of the rear surface trim 4 and the backboard 5 to the cover member 3.

### Summary of the Embodiment

The embodiment is summarized in the following manner.

A seat according to the embodiment includes a seatback. The seatback includes: a frame serving as a base of the seatback; a cover member that covers a front surface of the frame; a backboard that covers a rear surface of the frame; a skin that covers a rear surface of the backboard; and a first engaging member that fixes the skin to the cover member. The cover member has a front surface part that covers the front surface of the frame, a pair of side surface parts that cover side surfaces of the frame respectively, and a skin fixing part located in a space defined among the front surface part and the pair of side surface parts and having a first engaged hole which is engageable with the first engaging member. The skin has a main part that covers a rear side of the backboard, and an extension part extending from a peripheral edge of the main part and turning toward a front side of the backboard to be disposed between the backboard and the skin fixing part. The first engaging member fixes the extension part to the skin fixing part by penetrating the extension part and engaging with the first engaged hole of the skin fixing part.

In this configuration, the skin that covers the rear surface of the backboard has the main part that covers the rear side of the backboard, and the extension part extending from the peripheral edge of the main part and turning toward the front side of the backboard to be disposed between the backboard and the skin fixing part. The configuration enables the extension part to combine the skin and the backboard and thus achieve simultaneous attachment of the skin and the backboard.

In other words, in manufacturing the seatback, turning the extension part toward the front side of the backboard leads to achievement in combining the skin and the backboard. Besides, the first engaging member enables fixing of the extension part to the fixing part by penetrating the extension part and engaging with the first engaged hole of the skin fixing part of the cover member. The configuration enables the simultaneous fixing of the skin and the backboard to the skin fixing part of the cover member. This results in achieving improvement in the workability in the work of fixing the backboard and the skin at the rear side of the seatback.

In the seat, the skin preferably has a reinforcement part that reinforces at least a periphery of a portion of the extension part that the first engaging member penetrates.

In this configuration, the reinforcement part reinforces the periphery of the portion of the extension part of the skin that the first engaging member penetrates. The configuration prevents the first engaging member from elongating the through hole.

In the seat, the reinforcement part is preferably formed of a reinforcement plate member fixed to a front surface of the extension part to reinforce the extension part.

In this configuration, the reinforcement plate member serving as the reinforcement part is fixed to the front surface of the extension part to reinforce the extension part. The adoption of the reinforcement plate member leads to facilitated and ensured reinforcement of the whole of the extension part. The reinforcement plate member reliably brings out a straight line at an enfolding portion of the extension part, resulting in improving the appearance of the rear surface trim.

In the seat, the reinforcement plate member preferably has a reinforcement plate main part overlapping the extension part and a reinforcement plate extension part extending from the reinforcement plate main part to such a position as to avoid overlapping the extension part. The reinforcement plate extension part is preferably has a structure fixable to the front surface of the backboard.

This configuration in which the reinforcement plate extension part is fixed to a front surface of the backboard allows the reinforcement plate member to keep overlapping the backboard. This consequently avoids displacement of the reinforcement plate member relative to the backboard in the work of fixing the extension part of the skin to the skin fixing part of the cover member with the engaging fixing member, and thus improves the workability.

The seat preferably further includes a second engaging member that fixes the backboard to the frame. The frame preferably has a second engaged hole which is engageable with the second engaging member. The reinforcement plate extension part preferably has a third engaged hole being a through hole which is engageable with the second engaging member so that the reinforcement plate extension part is fixed to the front surface of the backboard. The second engaging member preferably fixes the backboard to the frame together with the reinforcement plate member by engaging the reinforcement plate extension part with the front surface of the backboard through the third engaged hole of the reinforcement plate extension part and engaging with the second engaged hole of the frame.

In this configuration, the second engaging member penetrates through the third engaged hole of the reinforcement plate extension part to engage the reinforcement plate extension part with the front surface of the backboard. The configuration consequently avoids displacement of the reinforcement plate member relative to the backboard in the work of fixing the extension part of the skin to the skin fixing part of the cover member with the engaging fixing member, and thus improves the workability. Further, the engagement of the second engaging member with the second engaged hole leads to fixing of the backboard to the frame together with the reinforcement plate member. This attains further stable fixing of the backboard, the reinforcement plate member, and the extension part of the skin to which the reinforcement plate member is fixed, and achieves improvement in accuracy of positioning and attachment of these components.

In the seat, the backboard may have a protrusion protruding frontward from the front surface of the backboard. The reinforcement plate extension part may have a fourth engaged hole which is engageable with the protrusion.

In this configuration, the protrusion protruding frontward from the front surface of the backboard engages with the fourth engaged hole of the reinforcement plate extension part to engage the reinforcement plate extension part with the front surface of the backboard. The configuration consequently avoids displacement of the reinforcement plate member relative to the backboard in the work of fixing the extension part of the skin to the skin fixing part of the cover member with the engaging fixing member, and thus improves the workability.

In the seat, the extension part of the skin preferably extends outward in a width direction of the main part from each of opposite side edges of the main part in the width direction, and the skin fixing part of the cover member is preferably provided to each of inner surfaces of the pair of side surface parts, the inner surfaces facing each other.

This configuration achieves stable support of the backboard from the opposite sides thereof in the width direction by allowing the pair of extension parts of the skin to turn toward the front side of the backboard. The configuration further enables stable fixing of the skin and the backboard to the skin fixing part respectively provided to the pair of side surface parts of the cover member.

A method for manufacturing a seat in the embodiment is a method for manufacturing the seat. The method includes: a step of preparing the skin with the extension part laid open relative to the main part; a step of making the first engaging member penetrate from a front side of the extension part; a step of combining the skin and the backboard by putting the main part of the skin over the rear surface of the backboard and turning the extension part toward the front side of the backboard together with the first engaging member; and a step of fixing the extension part to the skin fixing part by bringing the skin and the backboard in combination closer to the frame and the skin fixing part in the space of the cover member from the rear and engaging the first engaging member with the first engaged hole of the skin fixing part.

This configuration enables continuous execution of a step of combining the skin and the backboard by the extension part of the skin, and a step of simultaneously attaching the skin and the backboard to the skin fixing part of the cover member.

In other words, in manufacturing the seatback, turning the extension part toward the front side of the backboard together with the first engaging member after penetration of the first fixing member from the front side of the extension part of the skin leads to achievement in combining the skin and the backboard. At this time, the first engaging member is at the front side of the backboard. Subsequently to the step of combining the skin and the backboard, the skin and the backboard in combination are brought closer to the frame and the skin fixing part in the space of the cover member from the rear, and the first engaging member is made engage with the engaged hole of the skin fixing part of the cover member. The method enables fixing of the extension part to the skin fixing part. This results in achieving improvement in the workability in the work of fixing the backboard and the skin at the rear side of the seatback.

Conclusively, a seat and a method for manufacturing the seat according to the embodiment achieve improvement in workability in a work of fixing a backboard and a skin at a rear side of a seatback.

1. A seat, comprising:
a seatback, wherein
the seatback includes:
a frame serving as a base of the seatback;
a cover member that covers a front surface of the frame;
a backboard that covers a rear surface of the frame;
a skin that covers a rear surface of the backboard; and
a first engaging member that fixes the skin to the cover member,
the cover member has a front surface part that covers the front surface of the frame, a pair of side surface parts that cover side surfaces of the frame respectively, and a skin fixing part located in a space defined among the front surface part and the pair of side surface parts and having a first engaged hole which is engageable with the first engaging member,
the skin has a main part that covers a rear side of the backboard, and an extension part extending from a peripheral edge of the main part and turning toward a front side of the backboard to be disposed between the backboard and the skin fixing part, and
the first engaging member fixes the extension part to the skin fixing part by penetrating the extension part and engaging with the first engaged hole of the skin fixing part.

2. The seat according to claim 1, wherein the skin has a reinforcement part that reinforces at least a periphery of a portion of the extension part that the first engaging member penetrates.

3. The seat according to claim 2, wherein the reinforcement part is formed of a reinforcement plate member fixed to a front surface of the extension part to reinforce the extension part.

4. The seat according to claim 3, wherein the reinforcement plate member has a reinforcement plate main part overlapping the extension part and a reinforcement plate extension part extending from the reinforcement plate main part to such a position as to avoid overlapping the extension part, and
the reinforcement plate extension part has a structure fixable to a front surface of the backboard.

5. The seat according to claim 4, further comprising:
a second engaging member that fixes the backboard to the frame, wherein
the frame has a second engaged hole which is engageable with the second engaging member,
the reinforcement plate extension part has a third engaged hole being a through hole which is engageable with the second engaging member so that the reinforcement plate extension part is fixed to the front surface of the backboard, and
the second engaging member fixes the backboard to the frame together with the reinforcement plate member by engaging the reinforcement plate extension part with the front surface of the backboard through the third engaged hole of the reinforcement plate extension part and engaging with the second engaged hole of the frame.

6. The seat according to claim 4, wherein the backboard has a protrusion protruding frontward from the front surface of the backboard, and
the reinforcement plate extension part has a fourth engaged hole which is engageable with the protrusion.

7. The seat according to claim 1, wherein the extension part of the skin extends outward in a width direction of the main part from each of opposite side edges of the main part in the width direction, and
the skin fixing part of the cover member is provided to each of inner surfaces of the pair of side surface parts, the inner surfaces facing each other.

8. A method for manufacturing the seat according to claim 1, comprising:
a step of preparing the skin with the extension part laid open relative to the main part;
a step of making the first engaging member penetrate from a front side of the extension part;
a step of combining the skin and the backboard by putting the main part of the skin over the rear side of the backboard and turning the extension part toward the front side of the backboard together with the first engaging member; and
a step of fixing the extension part to the skin fixing part by bringing the skin and the backboard in combination closer to the frame and the skin fixing part in the space of the cover member from the rear and engaging the first engaging member with the first engaged hole of the skin fixing part.
